(19) United States
(12) Patent Application Publication
(10) Pub. No.: US 2012/0075651 A1
(43) Pub. Date: Mar. 29, 2012

(54) MANAGEMENT SYSTEM

(75) Inventor: Naoko SASASE, Itami-shi (JP)

(73) Assignee: KONICA MINOLTA BUSINESS TECHNOLOGIES, INC., Chiyoda-ku (JP)

(21) Appl. No.: 13/230,969

(22) Filed: Sep. 13, 2011

(30) Foreign Application Priority Data
Sep. 24, 2010 (JP) 2010-213787

(51) Int. Cl. G06F 3/12

(52) U.S. Cl. 358/1.13

(57) ABSTRACT

Disclose is a management system in which a reason why the user has selected an image forming apparatus that is currently in the power saving mode can be analyzed. The management system includes: plural image forming apparatuses, each of which is provided with a normal consumption mode and a power saving mode; a communication network through which the image forming apparatuses are communicatively coupled to each other; and a storage section that serves as a part of a management server coupled to the communication network or is included in at least one of the image forming apparatuses or another apparatus coupled to the communication network. When one of the image forming apparatuses resumes the normal consumption mode from the power saving mode to implement a job, the storage section acquires information in regard to an operating status of the other image forming apparatus so as to store the information therein.

This application is based on Japanese Patent Application NO. 2010-213787 filed on Sep. 24, 2010, with Japan Patent Office, the entire content of which is hereby incorporated by reference.

### BACKGROUND OF THE INVENTION

The present invention relates to a management system that includes a plurality of image forming apparatuses, each of which is provided with a normal consumption mode and a power saving mode as an electric power supplying mode and serves as a managed object, and stores operating histories of them, therein.

In recent years, with respect to a printer, an MFP (Multi-Functional Peripherals), etc., which are to be installed into an office environment or the like, the demands for saving electric energy to be consumed by them have increased considerably, and have been increasingly requested. To achieve this goal, the conventional apparatus is provided with such a function that, at the time when a standby state, in which neither a job to be implemented in the concerned apparatus nor an operation to be conducted by the user is present, has lasted for such a period that is equal to or more than a predetermined time interval, the electric power supplying mode of the concerned apparatus is made to automatically shift to the power saving mode (a sleeping state).

In addition to the above, there have been proposed various kinds of technologies for optimizing or improving the efficiencies of the operation for entering into the sleeping state and the other operation for recovering from the sleeping state, based on the usage history of the apparatus concerned. For instance, Tokkai 2006-334931 (Japanese Patent Application Laid-Open Publication) sets forth such the method that, based on the usage history of an apparatus (serving as a kind of image forming apparatus), the apparatus is immediately shifted from the sleeping state to the operating state in response to the status request command sent from the personal computer, which is frequently utilized by the user, while, the concerned apparatus does not recover from the sleeping state so as to still remain in the sleeping mode, when the status request command has been sent from the personal computer, which is seldom utilized by the user.

Further, Tokkai 2006-171297 sets forth such the method for determining functional sections to be recovered from the sleeping status, based on the operating history stored in advance. For instance, the apparatus so constituted that when the user wishes to conduct the operation for reading the document only, it is disabled to recover the printer section, based on the operating history thereof.

In such the case that more than two sets of image forming apparatuses, such as the printer, the MFP (Multi-Functional Peripherals), etc., exist in the same operating environment and are available for the user in the similar way, and any one of the image forming apparatuses is currently in the sleeping status, while the other one of the image forming apparatuses is in mid course of the operating status, it is effective to preferably employ the other image forming apparatus that is in mid course of the operating status, resulting in the suppression of the electric power consumption and the contribution for the electric energy saving aspect.

Concretely speaking, once the sleeping status is released, the power ON state of the concerned apparatus still lasts even after the implementation of the inputted job has been completed, while consuming the electric power. Accordingly, in such the operating environment that includes a plurality of image forming apparatuses, it is desirable for the user to preferably employ the image forming apparatus that is currently out of the sleeping state.

However, even if the user is guided (educated) to select such an image forming apparatus that is currently out of the sleeping state, by proposing information indicating the operating status of each of the image forming apparatuses, a specific image forming apparatus to be recommended to use from the energy saving point of view, etc., sometimes, the user employs such an image forming apparatus that should be recovered from the sleeping state. To overcome the abovementioned drawback, it is desirable to grasp the reason why the user forcibly selected the image forming apparatus that is currently in mid-course of the sleeping state, so as to parse and evaluate the reason above-grasped.

For instance, the reason why the user selects the image forming apparatus that is currently in mid-course of the sleeping state, as the job implementation destination apparatus, may be any one or any combination of justice reasons, including (1) all of the image forming apparatuses are in mid-course of the sleeping state, (2) the job implementation waiting time of the image forming apparatus currently operated is too long, due to a lot of the job reservations established in advance, (3) the image forming apparatus currently operated is located at a position far from the user's site, (4) the image forming apparatus currently operated is not provided with a function corresponding to the job desired by the user, or sometimes, may be a selfish reason, that is because the selected image forming apparatus is convenient for the user concerned, since that is simply located near the user's site irrespective of the current operation mode. Accordingly, it has been desired to grasp and analyze the reality of actual reasons so as to appropriately apply countermeasures to the abovementioned problem.

However, according to the method set forth by Tokkai 2006-334931 or Tokkai 2006-171297, since the image forming apparatus merely stores the usage history of its own, therein, it is impossible to grasp the relationships with the other image forming apparatuses, resulting in unhelpful to abovementioned analysis.

### SUMMARY OF THE INVENTION

To overcome the abovementioned drawbacks in conventional management systems, it is one of objects of the present invention to provide a management system, which makes it possible to collect history information that makes it possible to analyze the reason why the user has selected the image forming apparatus that is currently in the sleeping state.

Accordingly, at least one of the objects of the present invention can be attained by the management systems described as follows.

(1) According to a management system reflecting an aspect of the present invention, the management system, comprises: a plurality of image forming apparatuses, each of which is provided with a normal consumption mode and a power saving mode in which an amount of electric power consumption is lower than that in the normal consumption mode, as an electric power supplying mode, and each of which serves as a managed object to be managed in the management system; a communication network through which the image forming apparatuses are communicatively coupled to each other; and a storage section that serves as a part of a management server coupled to the communication network or is included in at least one of the image forming apparatuses or another apparatus coupled to the communication network; wherein, when one of the image forming apparatuses resumes the normal consumption mode from the power saving mode to implement a job, the storage section acquires first information in regard to an operating status of the other image forming apparatus so as to store the first information therein.
(2) According to another aspect of the present invention, in the management system recited in item 1, the storage section stores the first information in regard to the operating status of the other image forming apparatus, therein, only when one of the image forming apparatuses resumed the normal consumption mode from the power saving mode and has implemented the job.
(3) According to still another aspect of the present invention, in the management system recited in item 1, the storage section stores second information in regard to whether or not one of the image forming apparatuses resumed the normal consumption mode from the power saving mode and has implemented the job, and the first information in regard to the operating status of the other image forming apparatus at a time when implementing the job, while correlating the second information and the first information with each other.
(4) According to still another aspect of the present invention, in the management system recited in any one of items 1-3, the operating status includes the electric power supplying mode.
(5) According to still another aspect of the present invention, in the management system recited in any one of items 1-4, the operating status includes a number of reserved jobs and/or a waiting time defined as an time interval from a time when the job is inputted to anther time when implementation of the job is actually commenced.
(6) According to still another aspect of the present invention, in the management system recited in any one of items 1-5, the storage section further stores job information in regard to the job implemented by resuming the normal consumption mode from the power saving mode, while collating the job information with the first information in regard to the operating status.
(7) According to still another aspect of the present invention, in the management system recited in item 6, the job information includes third information in regard to a user who has inputted the job concerned.
(8) According to still another aspect of the present invention, in the management system recited in item 6, the job information includes fourth information in regard to a kind of the job.
(9) According to still another aspect of the present invention, the management system recited in any one of items 1-8, further comprises: an information providing section that serves as another part of the management server coupled to the communication network or is included in at least one of the image forming apparatuses or the other apparatus coupled to the communication network; wherein the information providing section provides reference information, which is to be used for selecting a specific image forming apparatus from the image forming apparatuses, with a terminal device that will transmit the job to the specific image forming apparatus serving as a destination apparatus to which a job is to be transmitted.
(10) According to still another aspect of the present invention, in the management system recited in any one of items 1-9, in addition to the first information in regard to the operating status of the other image forming apparatus, the storage section also stores fifth information in regard to another operating status of said one of the image forming apparatuses that has implemented the job.
(11) According to still another aspect of the present invention, the management system recited in any one of items 1-10, further comprises: the management server that is coupled to the communication network; wherein each of the image forming apparatuses includes the storage section, so that, when said one of the image forming apparatuses resumed the normal consumption mode from the power saving mode and has implemented the job, said one of the image forming apparatuses stores the first information in regard to the operating status of the other image forming apparatus into the storage section of said one of the image forming apparatuses; and wherein the management server collects the first information stored in each of the image forming apparatuses.
(12) According to still another aspect of the present invention, the management system recited in any one of items 1-10, further comprises: the management server that is coupled to the communication network and provided with the storage section; wherein, when said one of the image forming apparatuses resumed the normal consumption mode from the power saving mode and has implemented the job, said one of the image forming apparatuses notifies the management server of a fact that the normal consumption mode is resumed from the power saving mode and the job has been implemented in an own apparatus; and wherein, when receiving a notification of the fact as abovementioned, the management server stores the first information in regard to the operating status of the other image forming apparatus into the storage section provided in the management server.
(13) According to still another aspect of the present invention, the management system recited in any one of items 1-10, further comprises: the management server that is coupled to the communication network; and a terminal device that is coupled to the communication network and includes the storage section; wherein, when transmitting the job to said one of the image forming apparatuses, serving as a destination apparatus to which the job is to be transmitted, the terminal device stores the first information in regard to the operating status of the other image forming apparatus at the time when said one of the image forming apparatuses resumed the normal consumption mode from the power saving mode and has implemented the job, into the storage section of the terminal device; and wherein the management server collects the first information stored in the storage section of the terminal device.
(14) According to yet another aspect of the present invention, the management system recited in any one of items 1-10, further comprises: the management server that is coupled to the communication network and provided with the storage section; and a terminal device that is coupled to the communication network; wherein, on an occasion that the terminal device transmits the job to said one of the image forming apparatuses, serving as a destination apparatus to which the job is to be transmitted, when said one of the image forming apparatuses resumes the normal consumption mode from the power saving mode to implement the job, the terminal device notifies the management server of a fact that the normal consumption mode is resumed from the power saving mode and the job will be implemented in said one of the image forming apparatuses; and wherein, when receiving a notification of the fact as abovementioned, the management server stores the first information in regard to the operating status of the other image forming apparatus, other than said one of the image forming apparatuses, into the storage section provided in the management server.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram indicating a management system embodied in the present invention as the first embodiment;

FIG. 2 shows a block diagram indicating a rough configuration of an MFP embodied in the present invention;

FIG. 3 shows a block diagram indicating a rough configuration of a management server embodied in the present invention;

FIG. 4 shows a flowchart indicating an operational flow of an MFP (Multi-Functional Peripheral) monitoring processing to be conducted by a management server;

FIG. 5 shows a schematic diagram indicating an example of an electric power status table;

FIG. 6 shows a schematic diagram indicating an example of a job status table;

FIG. 7 shows a flowchart indicating a job reception processing to be conducted by an MFP at the time when receiving a job;

FIG. 8 shows a flowchart indicating a flow of operations to be conducted by a management server when receiving a notification of sleep release;

FIG. 9 shows a schematic diagram indicating a table of contents stored in a history database;

FIG. 10 shows a flowchart indicating detailed operations of an appropriate-or-inappropriate determination processing (Step S125 shown in FIG. 8);

FIG. 11 shows a flowchart indicating a flow of an extraction processing to be conducted by a management server;

FIG. 12 shows a schematic diagram indicating an example of an individual functional unit table in which correlating relationships between functions and functional units to be employed for implementing functions, respectively, are represented;

FIG. 13 shows a schematic diagram indicating an example of an electric power status table to be retained and updated by a management server embodied in the present invention as the second embodiment;

FIG. 14 shows a flowchart indicating a processing flow to be conducted by executing a driver program for an MFP, which is installed in an information processing apparatus;

FIG. 15 shows a schematic diagram indicating an example of a recommended MFP list to be displayed on a driver screen;

FIG. 16 shows a flowchart indicating a flow of operations to be conducted by an MFP at the time when receiving a job;

FIG. 17 shows a flowchart indicating a history information collection processing to be conducted by a management server embodied in the present invention as the third embodiment;

FIG. 18 shows a flowchart indicating a flow of processing to be conducted by executing a driver program installed in an information processing apparatus for driving an MFP; and

FIG. 19 shows a flowchart indicating a history information collection processing to be conducted by a management server embodied in the present invention as the fourth embodiment.

### DETAILED DESCRIPTION OF THE PREFERRED EMBODIMENT

Referring to the drawings, various kinds of embodiments of the present invention will be detailed in the following.

### First Embodiment

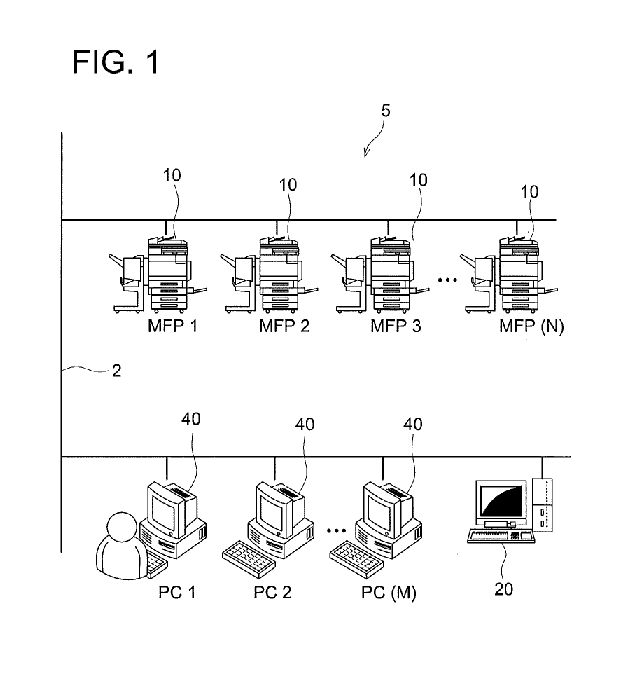

FIG. 1 shows a schematic diagram indicating a management system 5 embodied in the present invention as the first embodiment. The management system 5 is constituted by a plurality of MFPs (Multi-Functional Peripherals) 10 and a management server 20, which are coupled to each other through a network 2, such as LAN (Local Area Network), etc. Further, a plurality of information processing apparatuses 40, such as personal computers, etc., (hereinafter, also referred to as a PC 40) are coupled to the network 2 so as to transmit a job to any one of the MFPs 10.

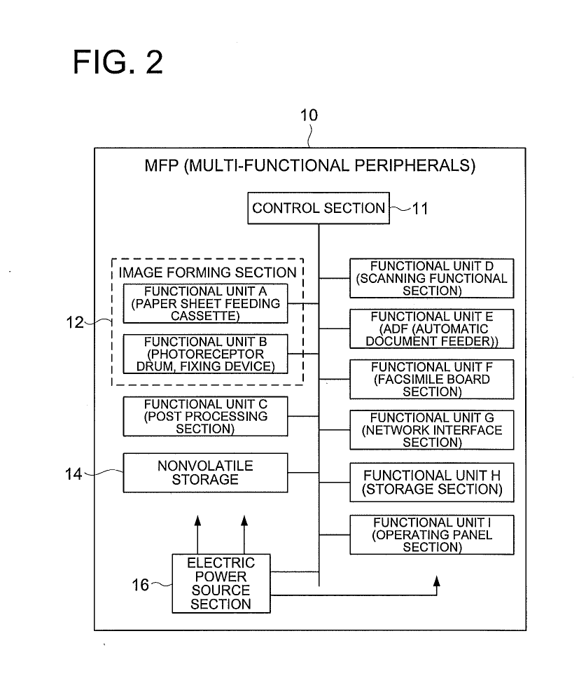

FIG. 2 shows a block diagram indicating a rough configuration of the MFP 10. The MFP 10 serves as an image forming apparatus that is provided with various kinds of functions, such as a copy function for optically reading a document so as to print its duplicate image onto a recording medium, a scanning function for making a file of image data representing an image read from the document to store the file therein and/or to transmit the file to an external terminal device through the network, a printing function for forming an image represented by the print data received from the information processing apparatus 40 or the like through the network 2 onto a recording medium so as to output the recording medium with the image as a printout, a facsimile function for bilaterally communicating the image data through the facsimile devices.

As shown in FIG. 2, the MFP 10 is provided with: a control section 11 to control overall operations to be conducted in the MFP 10; various kinds of functional units A through D to be controlled by the control section 11; a nonvolatile storage 14; and an electric power source section 16 to supply electric power to the control section 11, the various kinds of functional units A through D, the nonvolatile storage 14 and other sections.

The control section 11 is constituted by a CPU (Central Processing Unit), a ROM (Read Only Memory), a RAM (Random Access Memory), etc., as its main constituents, so that the CPU executes various kinds of programs stored in the ROM so as to implement the processing corresponding to the various kinds of programs for conducting the various kinds of functions provided in the MFP 10.

An image forming section 12 to form an image onto a recording paper sheet and to output the recording paper sheet with the image, is constituted by the functional unit A and the functional unit B. The functional unit A detects a size and a kind of paper sheets currently accommodated in the paper sheet feeding tray and picks up the paper sheets one by one so as to convey the picked-up paper sheet concerned. The functional unit B forms the image onto the paper sheet conveyed by the functional unit A and fixes the image onto the paper sheet concerned. The functional unit B is provided with a photoreceptor drum, a charging device, a laser unit, a developing device, a transferring separation device, a cleaning device, a fixing device, etc., so as to implement the image forming operations according to the electro-photographic process.

The functional unit D serves as a post processing section to apply postprocessing, such as a punch processing, a staple processing, a fold processing, etc., to the paper sheet ejected from the image forming section 12.

The functional unit D (scanning functional section) optically reads a document so as to acquire image data thereof. The functional unit E serves as an ADF (Automatic Document Feeder) that sequentially picks up document pages included in the document one by one and conveys the picked-up document page so as to make it pass through the document reading position of the functional unit D and eject onto the document ejection tray.

Further, other than the function for sequentially reading the document pages, conveyed by the functional unit E, one by one, the functional unit D is further provided with a function for reading the document placed (set) onto a platen glass. For instance, the functional unit D is constituted by a light source to emit light to be irradiated onto the document; a line image sensor to receive the light reflected from the document so as to read one line image of the document image in its width direction; a moving mechanism to move the document in its longitudinal direction along the rear surface of the platen glass so as to incrementally shift the reading position in a unit of line image when reading the document currently placed on the platen glass; an optical path, including lenses, minors, etc., to guide the light reflected from the document to the line image sensor so as to project the line image thereon; an analogue to digital converter to convert analogue image signals, outputted by the line image sensor, to digital image data etc.

The functional unit F (FAX circuit board section) is constituted by various kinds of electronic circuits for performing transmission/reception operations according to the facsimile communication protocol. The functional unit F (FAX circuit board section) conducts such operations for encrypting and decrypting the digital image data, calling call-in, controlling the facsimile communication protocol, etc.

The functional unit G (network interface section) serves as an interface for bilaterally communicating various kinds of data with the other MFPs 10, the management server 20, the information processing apparatus 40, etc., through the network 2.

The functional unit H (mass storage section) serves as, for instance, a nonvolatile mass storage device to be employed for storing print data, image data acquired by using the scanning function, etc. In addition, the history of the implemented job is also stored in the functional unit H.

The functional unit I (operating panel section) serves as an operation display panel to display various kinds of operational screens and setting screens thereon and to accept various kinds of operations, such as an operation for inputting job, an operation for setting job, etc., which are to be conducted by the user therefrom. The functional unit I is constituted by a display section including an LCD (Liquid Crystal Display), etc., an operating section including a touch panel mounted over the display section to detect a coordinate position depressed by the user, ten keys, character inputting keys, a start key, etc.

The nonvolatile storage 14 stores system information, user information, etc., therein. The system information includes an IP (Internet Protocol) address of the MFP 10 concerned, apparatus identification information (name and number, ID, etc.).

The electric power source section 16 converts the voltage value of the commercial power supply line to various kinds of voltage values respectively appropriate for the various kinds of sections provided in the MFP 10, so as to supply electric power to those sections. In addition, under the instructions issued by the control section 11, the electric power source section 16 is provided with a function for turning ON or OFF the electric power to be supplied to each of the sections. The MFP 10 is provided with a normal electric power consumption mode (hereinafter, referred to as normal consumption mode, for simplicity) in which the electric power is normally supplied to each of the sections so as to make them operable, and a power saving mode in which an amount of electric power consumption is lower than that in the normal consumption mode, as the power source supplying state (electric power supplying state), and the changeover between the normal consumption mode and the power saving mode is managed and controlled by the control section 11.

In the normal consumption mode, various kinds of jobs are implementable in the MFP 10. On the other hand, in the power saving mode, it is impossible to implement any job, while activated are only partial portions for monitoring whether or not an eventual factor for restoring the electric power supplying state to the normal consumption mode has occurred (for instance, reception of a job sent from the PC, an inputting operation conducted by the user, etc.). Further, the MFP 10 is so constituted that, once the normal consumption mode is restored, the electric power source section 16 continues to supply the electric power within a predetermined time interval (for instance, 10-30 minutes), even after the implementation of the current job has been completed, and then, the electric power supplying state is automatically shifted to the power saving mode if none of event, such as an implementation of new job, a user's operation, etc., has occurred within the predetermined time interval. In this connection, the normal consumption mode is also referred to as a power ON state, while the power saving mode is also referred to as a sleeping state. Further, hereinafter, to resume the electric power supply from the sleeping state (or to return to the normal consumption mode) is defined as a sleep release.

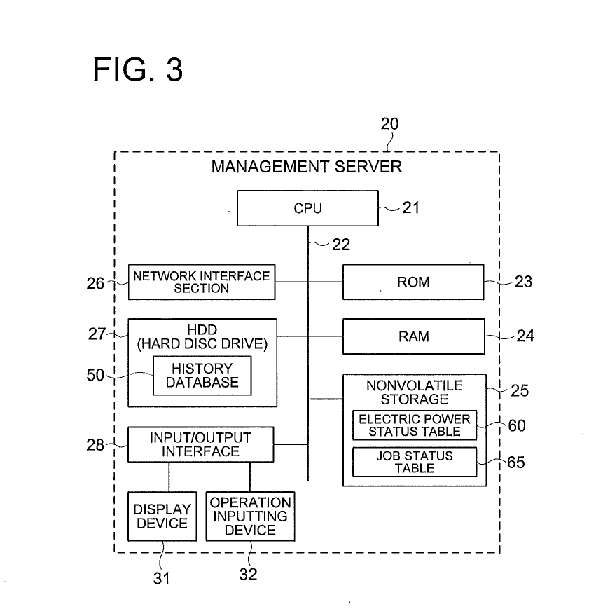

FIG. 3 shows a block diagram indicating a rough configuration of the management server 20 embodied in the present invention. The management server 20 monitors the operation statuses of each of the MFPs 10 (including information in regard to the electric power supplying state, a number of jobs currently reserved, a waiting time, etc.) and stores the operation statuses of each of the MFPs 10 as history information, therein, when the concerned MFP 10 resumed the normal consumption mode from the sleeping state and has implemented the job.

The management server 20 is provided with a CPU (Central Processing Unit) 21, and further provided with a ROM (Read Only Memory) 23, a RAM (Random Access Memory) 24, a nonvolatile storage 25, a network interface section 26, a HDD (Hard Disc Drive) 27, an input/output interface 28, etc., which are coupled to the CPU 21 through a bus 22. Further, a display device 31, such as an LCD (Liquid Crystal Display), etc., and an operation inputting device 32 including a keyboard, a mouse, etc. are coupled to the management server 20 through the input/output interface 28.

The ROM 23 stores boot-up programs and fixed data, therein, while the RAM 24 stores programs loaded from the HDD 27, therein. Further, the RAM 24 also serves as a working memory into which various kinds of data are temporarily stored at the time when the CPU 21 executes the programs concerned.

The nonvolatile storage 25, stored contents of which are not destroyed even when electric power supplied from the power source is turned OFF, stores various kinds of setting information, therein. Further, an electric power status table 60 into which the electric power supplying state of each of the MFPs 10 is registered, and a job status table 65 into which a number of reserved jobs, etc. of each of the MFPs 10 are registered, are created and stored into the nonvolatile storage 25.

The network interface section 26 serves as an interface that performs bilateral communications of various kinds of data with external apparatuses, such as the MFPs 10, the information processing apparatuses 40, etc., through the network 2.

The HDD 27 serves as a nonvolatile mass storage device that stores the OS (Operating System) program, the other operation programs, etc., therein. Further, the HDD 27 also stores history database 50 into which the history information of the sleep release are registered in an accumulation base, therein. Still further, the HDD 27 also stores layout information indicating the installed positions of the MFPs 10, the information processing apparatuses 40. For instance, each of the installed positions is represented by a coordinate position on a map indicating the office layout concerned. Yet further, the HDD 27 also stores the functions (capacities) provided in each of the MFPs 10 (kinds of implementable jobs), information in regard to the processing capability (printing velocity or the like), etc., therein.

The information processing apparatus 40 is provided with a function for inputting a job, such as a scanning job, a printing job, etc., into the MFP 10, so as to request the MFP 10 to implement the inputted job concerned. The information processing apparatus 40 is constituted by a personal computer into which the OS (Operating System) program, the driver program for driving the MFP 10, various kinds of application programs for creating and editing documents and images, etc. are installed, etc.

Next, the operations to be conducted in the management system 5 will be detailed in the following.

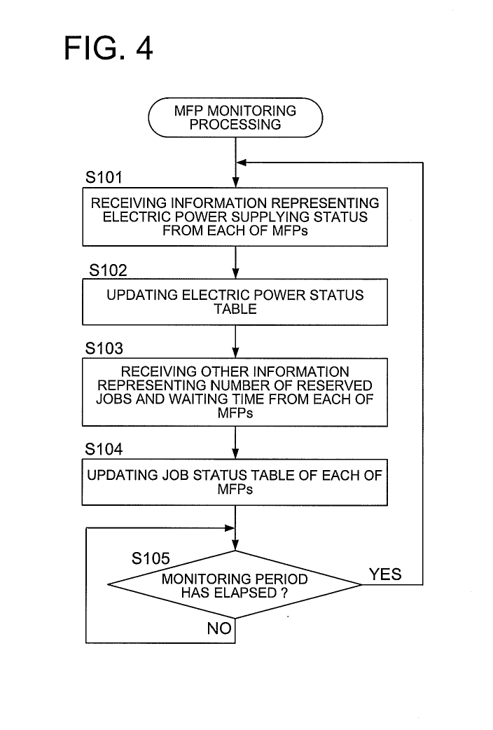

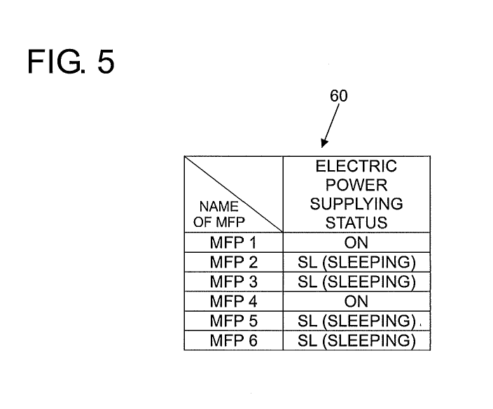

FIG. 4 shows a flowchart indicating an operational flow of the MFP monitoring processing to be conducted by the management server 20. The management server 20 communicates with each of the MFPs 10 coupled to the management system 5, so as to receive the information representing the current electric power supplying status of each of the MFPs 10 (Step S101), and then, updates the electric power status table 60 according to the received contents of the information concerned (Step S102). FIG. 5 shows a schematic diagram indicating an example of the electric power status table 60. As shown in FIG. 5, the name (such as MFP 1, MFP 2, etc.) and the electric power supplying status of MFP 10 are correlated with each other and registered for every one of the MFPs 10.

Further, the management server 20 communicates with each of the MFPs 10, so as to receive the other information representing the number of reserved jobs and the waiting time (Step S103; shown in FIG. 4), and then, updates the job status table 65 according to the contents of the other information above-received (Step S104). Hereinafter, the reserved job is defined as such a job that was inputted but is currently in an implementation waiting state. Further, the waiting time is defined as a time interval between the time when a next job was inputted and the other time when the implementation of the job concerned has been actually commenced.

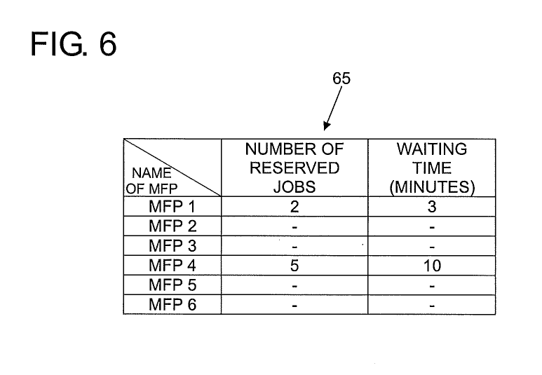

FIG. 6 shows a schematic diagram indicating an example of the job status table 65. As shown in FIG. 6, the name (such as MFP 1, MFP 2, etc.), the number of currently inputted reserved-jobs and the waiting time of MFP 10 are correlated with each other and registered for every one of the MFPs 10.

In the MFP monitoring processing indicated by the flowchart shown in FIG. 4, the management server 20 repeats implementing the abovementioned consecutive operations for every monitoring period (for instance, every 10 seconds) (Step S105). Accordingly, the management server 20 always grasps the latest operating status of each of the MFPs 10 coupled to the management system 5.

When transmitting a job, such as a print job, etc., to the MFP 10, the information processing apparatus 40 acquires the information in regard to the operating status of each of the MFPs 10 (concretely speaking, the electric power status table 60 and the job status table 65) from the management server 20, so as to determine a specific MFP to be recommended as a transmission destination apparatus of the concerned job, based on the information concerned, and shows the specific MFP to the user. According to the abovementioned recommendation processing, when both an MFP (or MFPs) operated in the normal consumption mode and another MFP (or other MFPs) operated in the power saving mode are currently intermingled in the management system 5, the information processing apparatus 40 preferentially recommends the MFP operated in the normal consumption mode as the specific MFP to the user concerned. Referring to the information shown by the information processing apparatus 40, the user selects one of the MFPs 10, which is to be serves as the transmission (implementation) destination apparatus of the job concerned. Then, the information processing apparatus 40 transmits the job to the MFP 10 selected by the user.

Referring to the information indicating the operating status of each of the MFPs 10 and the contents of recommendation, the user may select either the MFP 10, which is currently operated in the normal consumption mode, or the other MFP 10, which is currently operated in the power saving mode. Accordingly, the management system 5 is so constituted that, with respect to such the case that the job is implemented after the sleeping status has been release, the history information, which is to be used for analyzing and evaluating the reasons for the abovementioned case, are collected and stored. This procedure will be detailed in the following.

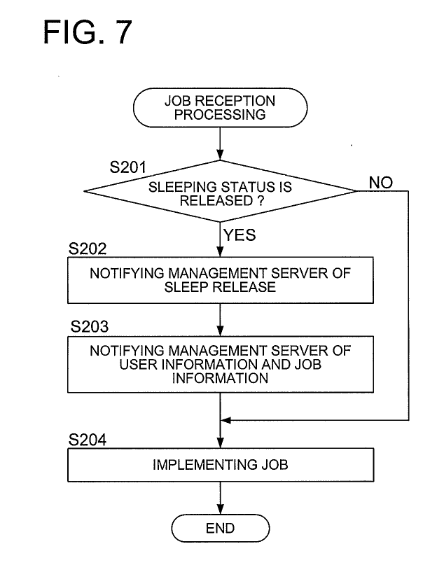

FIG. 7 shows a flowchart indicating a job reception processing to be conducted by the MFP 10. Initially, when receiving a job, the MFP 10 determines whether or not the own apparatus has released the sleeping status due to the concerned reception of the job (Step S201). When determining that the own apparatus has not released the sleeping status (Step S201; No), the MFP 10 implements the job concerned (Step S204), and then, finalizes the job reception processing (END).

On the other hand, when determining that the own apparatus has released the sleeping status due to the concerned reception of the job (Step S201; Yes), the MFP 10 notifies the management server 20 of the sleep release (Step S202). Further, the MFP 10 notifies the management server 20 of the user who inputted the job concerned (or information for specifying the information processing apparatus 40 serving as the sender of the job concerned) and transmits job information indicating the kind of the implemented job to the management server 20 (Step S203). Successively, the MFP 10 implements the job concerned (Step S204), and then, finalizes the job reception processing (END).

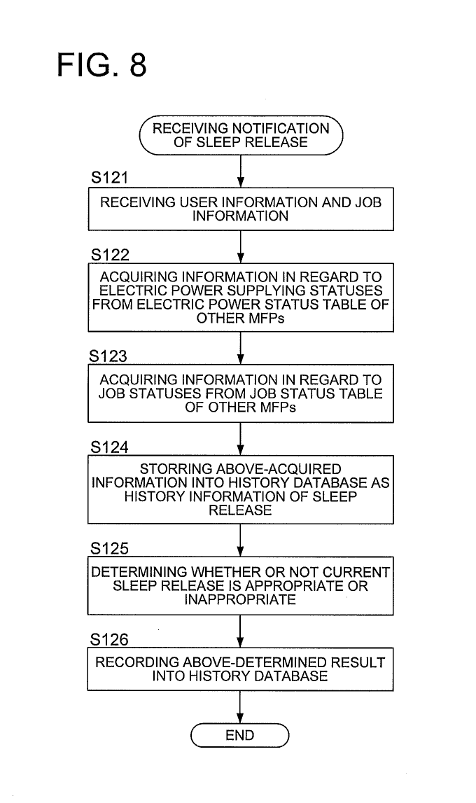

FIG. 8 shows a flowchart indicating a flow of operations to be conducted by the management server 20 when receiving the notification of the sleep release. At first, receiving the notification of the sleep release sent from the MFP 10, the management server 20 successively receives the job information (including the user information, the kind of the job concerned, etc.) also sent from the MFP 10 (Step S121). Referring to the electric power status table 60 and the job status table 65 stored in the own apparatus, the management server 20 acquires information in regard to the operating statuses (electric power supplying statuses and job statuses (each including a number of reserved jobs and a waiting time)) of MFPs 10 other than the MFP 10 serving as a sender currently transmitting the notification of the sleep release concerned (herein, defined as the other MFPs 10) (Step S122, Step S123). Then, the management server 20 stores the above-acquired information into the history database 50 as the history information of the sleep release (Step S124). In this connection, the present embodiment is so constituted that the management server 20 includes the operating status (the electric power supplying status and the job status) of the MFP 10 serving as a sender currently transmitting the notification of the sleep release concerned (herein, defined as the job implementation MFP 10) into the history information to be stored.

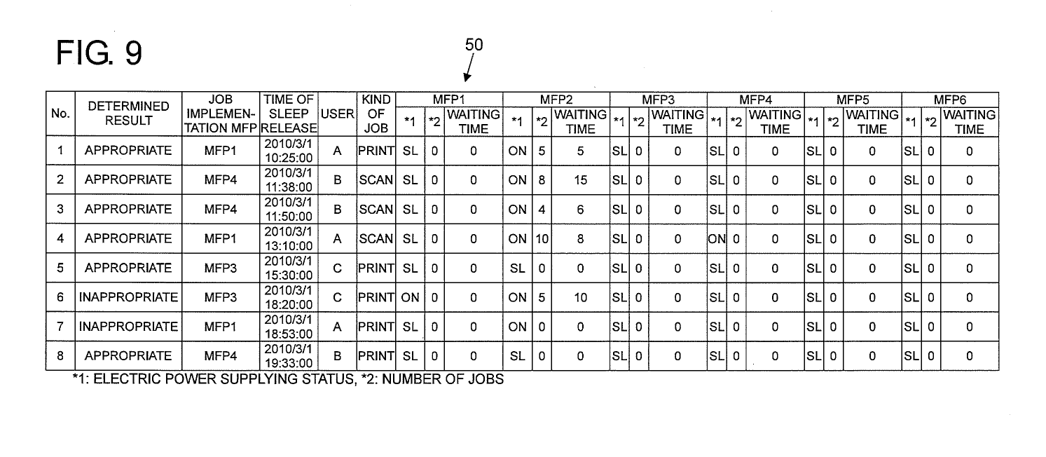

FIG. 9 shows a schematic diagram indicating a table of contents stored in the history database 50. One set of records is created for every job, currently released from the sleeping state, and stored into the history database 50 as the history information. Plural fields, including a serial number, a determined result (whether or not the sleep release is appropriate or inappropriate), a job implementation MFP, a time of the sleep release, a user (operator of the information processing apparatus 40, who has transmitted the job concerned), and a job kind (kind of job actually implemented) are established in one set of records as the fundamental items. Further, other fields, in which the operating information for 10 sets of MFPs 10 serving as the managed objects is registered, are also established. The operating information of each of the MFPs 10 is constituted by fields of an electric power supplying status, a number of reserved jobs and a waiting time. In this connection, in the field of the electric power supplying state of the history database 50 shown in FIG. 9, the symbol “ON” represents the normal consumption mode, while the symbol “SL” represents the sleeping state.

In the example shown in FIG. 9, the MFPs 10 serving as the managed objects are the MFP1 through MFP6, and 8 sets of records from No. 1 through No. 8, namely the history information with respect to the 8 jobs, which were released from the sleeping state and have been implemented, are registered.

Returning to the flowchart shown in FIG. 8, the explanations for the operations will be continued in the following. After recording the history information in regard to the current sleep release, the management server 20 determines whether or not the current sleep release is appropriate or inappropriate (Step S125).

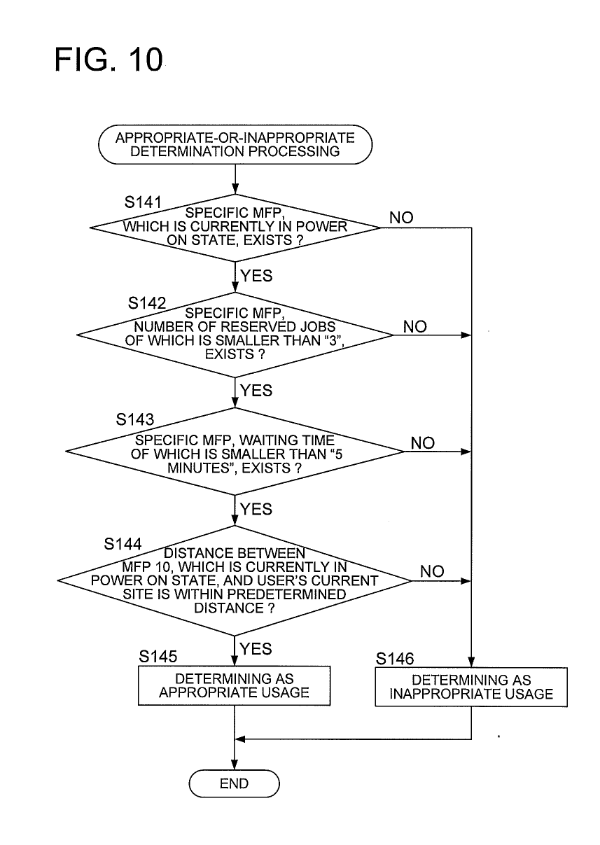

FIG. 10 shows a flowchart indicating detailed operations of the appropriate-or-inappropriate determination processing (Step S125 shown in FIG. 8). The management server 20 determines whether or not a specific MFP 10, which is currently in the power ON state (electric power supplying state is the normal consumption mode), exists among the other MFPs 10 (Step S141). When determining that a specific MFP 10 does not exist (Step S141; No), the management server 20 determines the concerned MFP 10 as the “appropriate usage” (Step S146).

When determining that MFPs 10, which are currently in the power ON state, exist among the other MFPs 10 (Step S141; Yes), the management server 20 further determines whether or not a specific MFP 10, a number of reserved jobs of which is smaller than a predetermined number (herein, “3”), exists among the MFPs 10, which are currently in the power ON state (Step S142). When determining that a specific MFP 10 does not exist (Step S141; No), the management server 20 determines the concerned MFP 10 as the “appropriate usage” (Step S146).

When determining that MFPs 10, numbers of reserved jobs of which are smaller than the predetermined number, exist among the MFPs 10 (Step S142; Yes), the management server 20 still further determines whether or not a specific MFP 10, a waiting time of which is smaller than a predetermined time interval (herein, “5 minutes”), exists among the MFPs 10, numbers of reserved jobs of which are smaller than the predetermined number, (Step S143). When determining that a specific MFP 10 does not exist (Step S143; No), the management server 20 determines the concerned MFP 10 as the “appropriate usage” (Step S146).

When determining that MFPs 10, waiting times of which are smaller than the predetermined time interval (Step S143; Yes), exist among the MFPs 10, numbers of reserved jobs of which are smaller than the predetermined number (Step S143; Yes), the management server 20 yet further determines whether or not a distance between the MFP 10, which is currently in the power ON state, and the user's current site (the information processing apparatus 40 serving as the sender of the job) is within a predetermined distance (for instance, 10 meters) (Step S144). This determining operation is conducted on the basis of the layout information stored in the management server 20. Concretely speaking, since a position of each of the MFPs 10 and another position of the information processing apparatus 40 can be recognized (derived) from the layout information, the management server 20 can find the distance between the position of the MFP 10, which is currently in the power ON state, and the other position of the information processing apparatus 40 serving as the sender of the job, from the layout information so as to conduct the determining operation abovementioned.

When determining that the distance between the MFP 10 and the user's current site is larger than the predetermined distance (Step S144; No), the management server 20 determines the concerned MFP 10 as the “appropriate usage” (Step S146), while, when determining that the distance between the MFP 10 and the user's current site is within the predetermined distance (Step S144; Yes), the management server 20 determines the concerned MFP 10 as the “inappropriate usage” (Step S145).

The management server 20 records the above-determined result in regard to the appropriate-or-inappropriate determination processing into the column of determined result corresponding to the concerned record (Step S126 in the flowchart shown in FIG. 8) and finalizes the processing (END).

For instance, according to the example of the history database 50 shown in FIG. 9, with respect to the Record No. 1, since both the number of reserved jobs and the waiting time of the MFP2 have exceeded the predetermined setting values, respectively, though the MFP2 is currently in the power ON state, the implementation of the job concerned after the sleep release is determined as the “appropriate usage”. The Record No. 2 is the same as the Record No. 1.

Further, with respect to the Record No. 3, since the waiting time of the MFP2 has exceeded the predetermined setting value, though the MFP2 is currently in the power ON state and the number of reserved jobs is equal to or lower than the predetermined setting value, the implementation of the job concerned after the sleep release is determined as the “appropriate usage”.

Still further, with respect to the Record No. 4, the MFP2 and the MFP4 are currently in the power ON state, while, both the number of reserved jobs and the waiting time of the MFP2 have exceeded the predetermined setting values, respectively. Although both the number of reserved jobs and the waiting time of the MFP4 are lower than the predetermined setting values, respectively, since the position of the MFP4 is far from the site of the user “A”, the implementation of the job concerned after the sleep release is determined as the “appropriate usage”.

Still further, with respect to the Record No. 5, since all of the MFPs are currently in the power ON state, the implementation of the job concerned after the sleep release is determined as the “appropriate usage”.

Still further, with respect to the Record No. 6, since both the number of reserved jobs and the waiting time of the MFP1 are equal to or lower than the predetermined setting values, respectively, though the MFP1 and the MFP2 are currently in the power ON state, the implementation of the job concerned after the sleep release is determined as the “inappropriate usage”.

Yet further, with respect to the Record No. 7, although only the MFP2 is currently in the power ON state, since both the number of reserved jobs and the waiting time are equal to or lower than the predetermined setting values, respectively, the implementation of the job concerned after the sleep release is determined as the “inappropriate usage”. The Record No. 8 is the same as the Record No. 5.

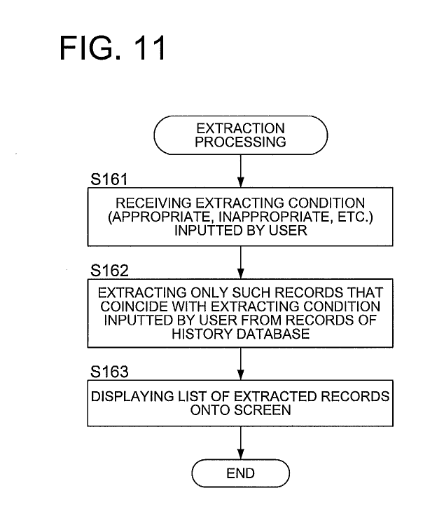

FIG. 11 shows a flowchart indicating a flow of an extraction processing to be conducted by the management server 20. By implementing the extraction processing, it becomes possible to extract only a record or records, which is/are determined as the “appropriate usage”, or only a record or records, which is/are determined as the “inappropriate usage”, so as to display it/them on the display screen. At first, the management server 20 receives an extracting condition inputted by the user (Step S161). For instance, the extracting condition includes an instruction for extracting only the record determined as the “appropriate usage”, an instruction for extracting only the record determined as the “inappropriate usage”, etc.

Successively, the management server 20 extracts only such the records that coincide with the extracting condition inputted by the user (Step S162), and creates a list including the contents of the records above-extracted so as to display the list onto the display device 31 (Step S163).

In this connection, it is applicable that the management server 20 stores not only the determined results of the appropriate-or-inappropriate determination processing shown in FIG. 10, but also the corresponding reasons why it is determined as the “appropriate usage” as a part of the history information of the sleep release, so as to also display the reasons on the above-created list. Further, it is also applicable that the system is so constituted that the reason why it is determined as the “appropriate usage” can be added to the extracting condition, so as to extract only such a record that is determined as appropriate due to a specific reason.

For instance, when the management server 20 determines the concerned MFP 10 as the “appropriate usage” corresponding to the determination of “No” in Step S141 in the flowchart shown in FIG. 10, the management server 20 may store the message of “NONE OF MFPS ARE CURRENTLY IN POWER ON STATE” as its determination reason, while, when the management server 20 determines the concerned MFP 10 as the “appropriate usage” corresponding to the determination of “No” in Step S142, the management server 20 may store the message of “NONE OF MFPS CURRENTLY HAVE NUMBER OF RESERVED JOBS LOWER THAN 3” as its determination reason, as a part of its history information.

Since the operating statuses of the other MFPs at the time when the job is implemented after the sleep release has been completed, are stored into the history database 50, it is possible to presume the reason of the sleep release from the operating statuses of the other MFPs. Concretely speaking, by analyzing and estimating the history information in regard to the sleep release stored in the history database 50, it becomes possible to ascertain the reason of the sleep release, and when the concerned reason has been ascertained, it becomes possible to apply a countermeasure corresponding to the above-ascertained reason.

For instance, when the reason why the implementation of the job after the sleep release is determined as the “appropriate usage” is represented by the message of “MFP CURRENTLY IN POWER ON STATE IS FAR FROM USER'S SITE”, it is possible to employ such a countermeasure for updating the current installed position of the concerned MFP or the information processing apparatus 40 used by the user. Further, when the reason why the implementation of the job after the sleep release is determined as the “appropriate usage” is represented by the message of “WAITING TIME IS TO LONG SINCE LOT OF JOBS ARE RESERVED IN MFP CURRENTLY IN POWER ON STATE”, it can be considered such a state that jobs are concentrated to a certain limited MFP, despite that plural MFPs exist in the same environment. To cope with such the case as abovementioned, it is possible to employ such a countermeasure for updating the determination algorism of the recommended MFP so as to make it possible to effectively use the MFPs without making them enter into the sleeping state by dispersing the jobs to increase the number of MFPs, which are currently in the power ON state.

Further, in the case that the sleep release is conducted without indicating any reasonable circumstances (when determined as the “inappropriate usage”), it is possible to employ countermeasures to suppress the inappropriate usage, such as increasing an amount of accounting for the concerned job to be charged to the user, warning the user concerned, etc.

### Second Embodiment

Next, another management system 5, embodied in the present invention as the second embodiment, will be detailed in the following.

Although the management system 5, serving as the first embodiment, is so constituted that the MFP 10 that has released the sleeping state to implement the job transmits the notification thereof to the management server 20, the other management system 5, serving as the second embodiment, is so constituted that, when transmitting a job to the MFP 10, which is currently in the sleeping state, the information processing apparatus 40 transmits the notification of the sleep release to the management server 20.

Further, although such the case that the electric power supplying mode is changed between the normal consumption mode and the sleeping state (power saving mode) in a unit of MFP 10 has been exemplified as the first embodiment, the management system 5 serving as the second embodiment is so constituted that each of the MFPs 10 can control both the power ON state and the sleeping state in a unit of function, and corresponding to a kind of a job, can release only such a functional unit, that is necessary for implementing the concerned job, from the sleeping state.

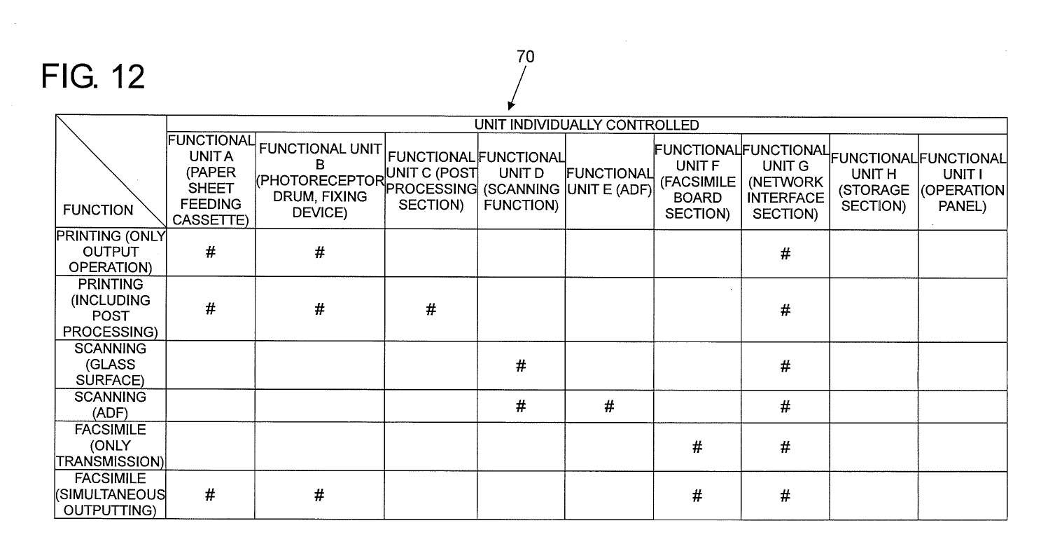

FIG. 12 shows a schematic diagram indicating an example of an individual functional unit table 70 in which correlating relationships between functions and functional units to be respectively employed for implementing the functions are represented. For instance, the individual functional unit table 70 is stored into each of the MFPs 10, the management server 20 and the information processing apparatus 40.

The functions registered in the individual functional unit table 70 relate to such a job that can be inputted to the MFP 10 from the information processing apparatus 40, and include a printing (only output operation), a printing (including post processing), a scanning (glass surface), a scanning (ADF (Automatic Document Feeder)), a facsimile (only transmission) and a facsimile (simultaneous outputting). In the individual functional unit table 70 shown in FIG. 12, the units being necessary to implement each of the functional operations are represented by the symbol “#” marked in the column corresponding to each of the functional units.

In regard to the functional operation of the printing (only output operation), the functional unit A, the functional unit B and the functional unit G are employed, so that the image forming section 12 implements the printing operation based on the print data received from the information processing apparatus 40. In regard to the functional operation of the printing (including post processing), the functional unit A, the functional unit B, the functional unit C and the functional unit G are employed, so that the image forming section 12 implements the printing operation based on the print data received from the information processing apparatus 40, and then, the post processing, such as a punch processing, a bind processing, a fold processing, etc., are applied to the print products, outputted by the image forming section 12.

Further, in regard to the functional operation of the scanning (glass surface), the functional unit D and the functional unit G are employed, so as to read the image of the document placed on the platen glass, and to transmit the digital image data thereof to the external apparatus, such as the information processing apparatus 40, etc., through the network 2. In regard to the functional operation of the scanning (ADF), the functional unit D, the functional unit E and the functional unit G are employed, so that the Automatic Document Feeder sequentially picks up and conveys a single or plural paper sheets of the document one by one so as to read the image(s) of the document, and to transmit the digital image data thereof to the external apparatus, such as the information processing apparatus 40, etc., through the network 2.

Still further, in regard to the functional operation of the facsimile (only transmission), the functional unit F and the functional unit G are employed, so as to transmit the image data received from the information processing apparatus 40 to the destination apparatus having the designated address through the facsimile transmission process. In regard to the functional operation of the facsimile (simultaneous outputting), the functional unit A, the functional unit B, the functional unit F and the functional unit G are employed, so as to transmit the image data received from the information processing apparatus 40 to the destination apparatus having the designated address through the facsimile transmission process, and at the same time, to make the image forming section 12 output the printout(s).

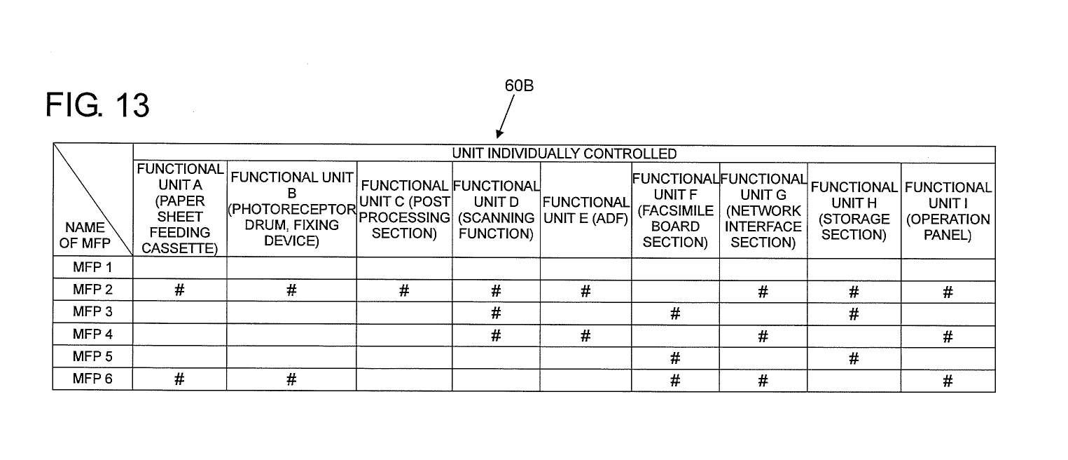

FIG. 13 shows a schematic diagram indicating an example of an electric power status table 60B to be retained and updated by the management server 20 embodied in the present invention as the second embodiment. Into the electric power status table 60B, the electric power supplying status of each of the functional units is registered for every MFP 10. In the FIG. 13, the symbol “#” marked in the column corresponding to each of the functional units represents the electric power supplying mode in which the electric power is currently supplied, while the absence of the symbol represents the sleeping state.

According to the second embodiment, the management server 20 receives the electric power supplying statuses of individual functional units from each of the MFPs 10, in Step S101 of the flowchart of the MFP monitor processing shown in FIG. 4. Further, in Step S102, the management server 20 updates the electric power status table 60B shown in FIG. 13, instead of the electric power status table 60 shown in FIG. 5.

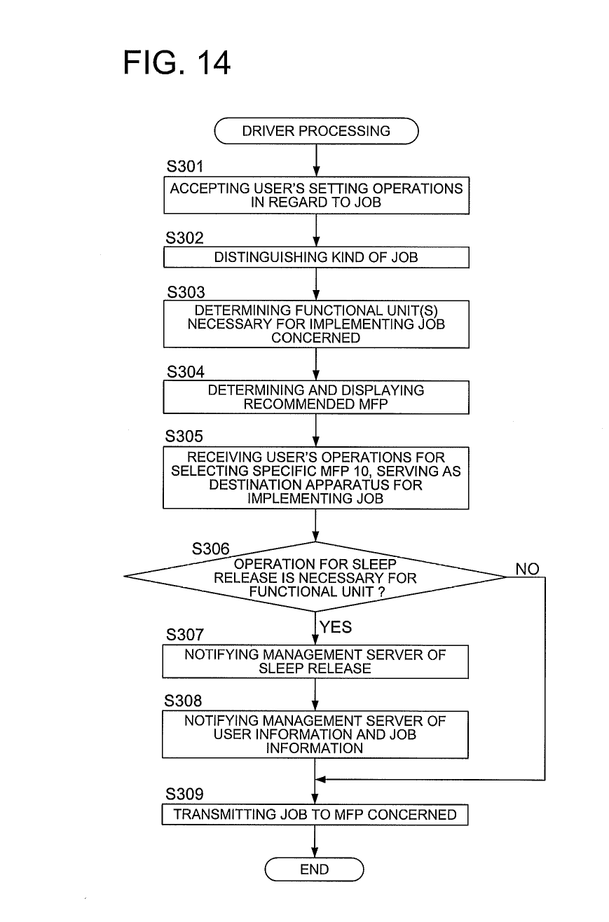

FIG. 14 shows a flowchart indicating a processing flow to be conducted by executing the driver program for MFP 10, which is installed in the information processing apparatus 40. Initially, by executing the driver program after booting it, a CPU (Central Processing Unit) 41 of the information processing apparatus 40 displays the predetermined driver screen on the display area of the information processing apparatus 40, so as to accept the user's setting operations in regard to a job (Step S301). Then, the CPU 41 distinguishes a kind of the job (Step S302), and refers to the individual functional unit table 70 so as to determine the functional unit(s) necessary for implementing the job concerned (Step S303). In the second embodiment, it is assumed that the individual functional unit table 70 is stored in advance into the driver program.

Successively, the CPU 41 of the information processing apparatus 40 determines one of the MFPs 10 as a recommended MFP, which is recommended as the destination apparatus for implementing the job concerned, to display the recommended MFP thereon (Step S304). For instance, the information processing apparatus 40 acquires information in regard to the electric power supplying status from each of the MFPs 10, or obtains electric power status table 6013 from the management server 20. Then, the information processing apparatus 40 preferentially recommend such an MFP 10 in which all of the functional units, determined as necessary in Step S303, are currently in ON state (namely, the MFP for which the operation for the sleep release is unnecessary).

In this connection, when the operation for the sleep release is unnecessary for plural MFPs 10, the smaller a number of functions available for other purpose in the current electric power supplying status, provided in an MFP 10, is among the plural MFPs 10 concerned, the higher the recommended priority of such the MFP 10 is ranked. This is because, it is desirable that the MFP 10 having the functions available for another purpose is made to open for the other user who possibly desires to use the concerned functions available for the other purpose.

Further, in regard to the MFP 10 for which the operation for the sleep release is necessary, if the functional unit to be released from the sleeping state is only one, the recommended priority of the MFP 10, in which a number of the functions available for another purpose is great when the sleep release has been completed, is made to be high, while, if plural functional units to be released from the sleeping state exist, the recommended priority of the MFP 10, in which a number of the functions to be released from the sleeping state is small, is made to be high.

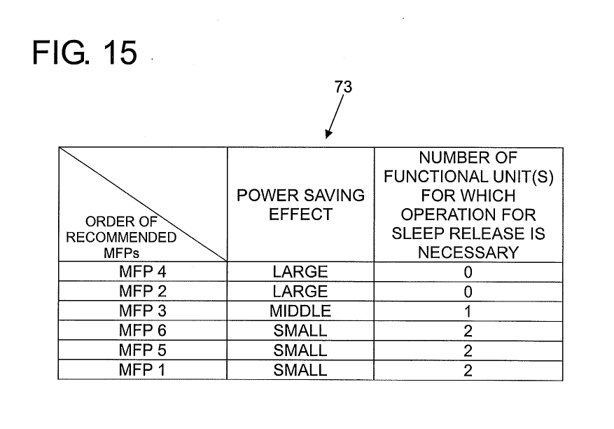

FIG. 15 shows a schematic diagram indicating an example of a recommended MFP list 73 to be displayed on the driver screen. In the recommended MFP list 73, the recommended MFPs are displayed in order of recommended priorities of them. In the example shown in FIG. 15, the names of MFPs 10 (such as MFP1, MFP2, etc.), the large or small of the power saving effect, and the number of functional unit(s) for which the operation for sleep release is/are necessary, are indicated in order of recommended priorities of them, while correlating them with each other.

Returning to the flowchart shown in FIG. 14, after displaying the recommended MFP list 73 shown in FIG. 15 onto the driver screen, the information processing apparatus 40 receives the user's operations for selecting a specific MFP 10, serving as a destination apparatus for implementing the job concerned (Step S305). Receiving the selecting operations concerned, the information processing apparatus 40 determines whether or not the operation for the sleep release is necessary for the functional unit (Step S306), when the job is to be implemented in the specific MFP 10 selected by the user. For instance, in the case of the printing job, the information processing apparatus 40 determines whether or not the operation for the sleep release is necessary for each of the functional units A, B and G. When determining that the operation for the sleep release is necessary for any one of the functional units A, B and G, the information processing apparatus 40 determines that the operation for the sleep release is necessary.

Successively, when determining that the operation for the sleep release is necessary (Step S306; Yes), the information processing apparatus 40 notifies the management server 20 of the sleep release in regard to the specific MFP 10 (Step S307). Further, the information processing apparatus 40 transmits the job information, representing the user who inputted the job concerned (or information for specifying the information processing apparatus 40 concerned), the kind (function) of the job implemented, etc., to the management server 20, so as to notify the management server 20 of them (Step S308). Then, the information processing apparatus 40 transmits the job to the specific MFP 10 selected in Step S305 by the user (Step S309), and finalizes the processing (END).

When determining that the operation for the sleep release is not necessary (Step S306; No), shifting to Step S309, the information processing apparatus 40 transmits the job to the specific MFP 10 selected in Step S305 by the user (Step S309), and finalizes the processing (END).

In this connection, in such the case that the electric power supplying status of each of the functional units is individually controlled as in the second embodiment, when registering the history information of the sleep release into the history database 50 in the processing indicated in the flowchart shown in FIG. 8, the management server 20 registers the normal consumption mode (represented by the symbol of “ON”) as its electric power supplying mode, if all of functional units, which are necessary for implementing the job indicated by the kind of the job, are currently in the power ON state, while, registers the sleeping state (represented by the symbol of “SL”) as its electric power supplying mode, if any one of functional units, which are necessary for implementing the job indicated by the kind of the job, is currently in the sleeping state. Incidentally, it is also applicable that the management server 20 registers all of the contents in the electric power status table 60B, established at the time when accepting the notification of the sleep release, into the history database 50, as the electric power supplying statuses of the MFPs 10 at that time.

Further, in this connection, even in such the configuration that the MFP 10 transmits the notification of the sleep release to the management server 20 as in the first embodiment, it is also applicable that the system is so constituted that the electric power supplying statue of each of the functional units is individually controlled and managed.

### THIRD EMBODIMENT

Next, still another management system 5, embodied in the present invention as the third embodiment, will be detailed in the following.

In the third embodiment, the management system 5 is so constituted that each of the MFPs 10 stores the history information at the time when the own apparatus had been released from the sleeping state by itself and implemented a job, therein, so that the management server 20 can collect the history information from the MFPs 10 as needed, so as to create the history database 50.

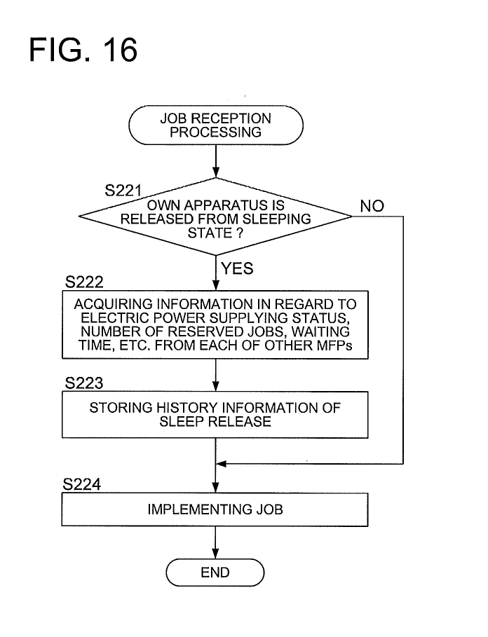

FIG. 16 shows a flowchart indicating a flow of operations to be conducted by the MFP 10 at the time when receiving the job concerned. Initially, when receiving the job, the MFP 10 determines whether or not the own apparatus is released from the sleeping state by itself (Step S221). When determining that the own apparatus is not released from the sleeping state (Step S221; No), the MFP 10 implements the job concerned (Step S224), and finalizes the processing (END).

On the other hand, when determining that the own apparatus is released from the sleeping state (Step S221; Yes), the MFP 10 acquires information in regard to the operating status of each of the other MEPs 10 (such as an electric power supplying status, a number of reserved job, a waiting time, etc.) (Step S222). In this connection, it is applicable that the MFP 10 concerned inquires each of the other MFPs 10 to acquire the abovementioned information, or if the management server 20 retains the electric power status table 60 (or 60B) and/or the job status table 65 as a result of implementing the MFP monitor processing, the MFP 10 concerned acquires the abovementioned information from the management server 20.

The MFP 10 concerned stores the information in regard to the operating status of each of the other MFPs 10, which has been acquired through the abovementioned process, into the Hard Disc Drive (functional unit H) or the like (Step S223). The items to be stored are indicated as a part of the history database 50 shown in FIG. 9, excluding the fields of “DETERMINED RESULT” and “JOB IMPLEMENTATION MFP” therefrom. Since the MFP 10 stores the history information at the time when the own apparatus implements the job concerned, the “JOB IMPLEMENTATION MFP” is automatically equivalent to the own apparatus, and accordingly, it is unnecessary for the concerned MFP 10 to store the information of this item. Further, since the management server 20 conducts the operation for determining “APPROPRIATE” or “INAPPROPRIATE”, the MFP 10 does not store this item.

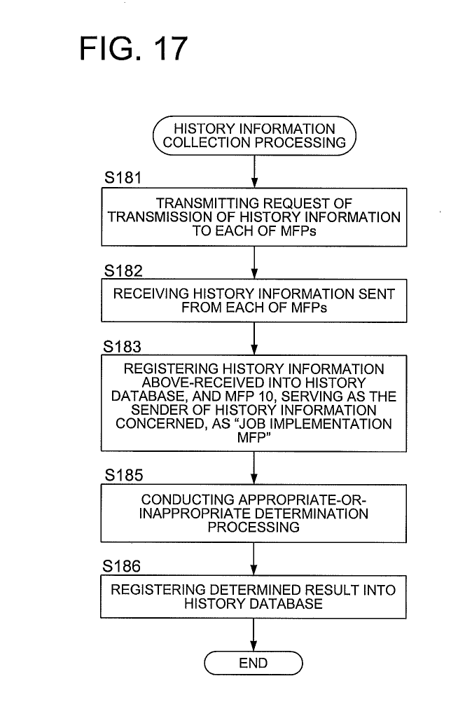

FIG. 17 shows a flowchart indicating a history information collection processing to be conducted by the management server 20 embodied in the present invention as the third embodiment. The history information collection processing is implemented at every predetermined period (for instance, once a day at a predetermined time), or at the time when the instruction is received from the manager or the like.

Initially, the management server 20 transmits a request of transmission of the history information to each of the MFPs 10 (Step S181). Receiving the request of transmission, the MFP 10 transmits the history information, currently stored in the own apparatus, to the management server 20. Receiving the history information sent from each of the MFPs 10 (Step S182), the management server 20 registers the history information above-received into the history database 50 (Step S183). On that occasion, the management server 20 also registers the MFP 10, serving as the sender of the history information concerned, as the “JOB IMPLEMENTATION MFP”.

Successively, the management server 20 conducts the appropriate-or-inappropriate determination processing (Step S185), so as to register the determined result thereof into the history database 50 (Step S186), and then, finalizes the processing (END). In this connection, the operation to be conducted in Step S185 is equivalent to that in Step S125 of the flowchart shown in FIG. 8, and the other operation to be conducted in Step S186 is equivalent to that in Step S126 of the flowchart shown in FIG. 8.

### Fourth Embodiment

Next, yet another management system 5, embodied in the present invention as the fourth embodiment, will be detailed in the following.

The fourth embodiment is so constituted that each of the information processing apparatuses 40 stores the history information at the time when transmitting a job to the MFP 10, which is currently in the sleeping state (in such the case that the MFP 10, serving as the destination apparatus of the job concerned, conducts operations for the sleep release due to the reception of the job concerned), so that the management server 20 collects the history information from each of the information processing apparatuses 40 as needed, to create the history database 50.

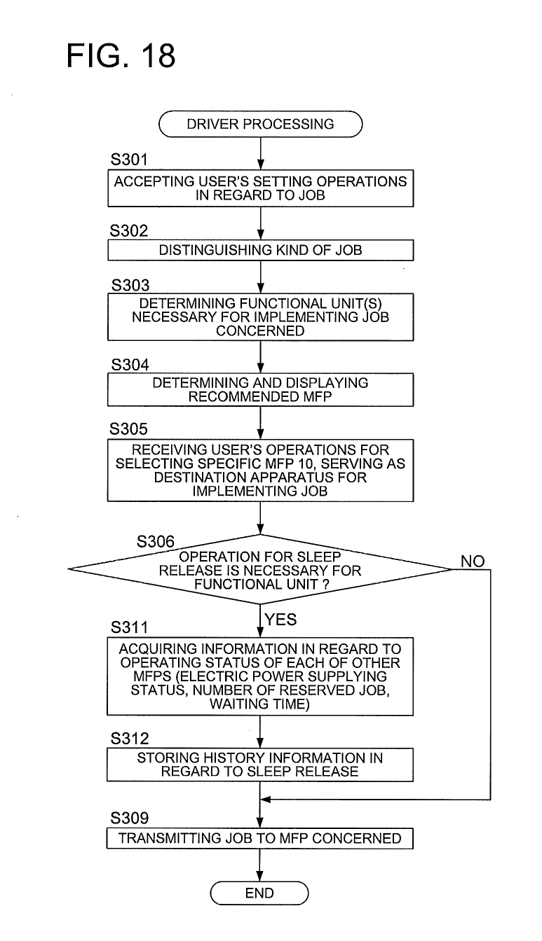

FIG. 18 shows a flowchart indicating a flow of processing to be conducted by executing the driver program installed in the information processing apparatus 40 for driving the MFP 10. In this connection, the same step numbers are attached to the same operations as those in the flowchart shown in FIG. 14, respectively, and the explanations for them will be omitted. The flowchart shown in FIG. 18 is different from that shown in FIG. 14, on the point that Step S311 and Step S312, which are to be implemented when determining as “Yes” in Step S306, are newly added to the flowchart shown in FIG. 18.

Concretely speaking, when the specific MFP selected by the user is such an MFP 10 that requires the operation for implementing the sleep release (Step S306; Yes), the information processing apparatus 40 acquires information in regard to the operating status of each of the other MFPs 10 (such as an electric power supplying status, a number of reserved job, a waiting time, etc.) (Step S311). In this connection, it is applicable that the information processing apparatus 40 concerned inquires each of the other MFPs 10 to acquire the abovementioned information, or if the management server 20 retains the electric power status table 60 (or 60B) and/or the job status table 65 as a result of implementing the MFP monitor processing, the information processing apparatus 40 concerned acquires the abovementioned information from the management server 20.

The information processing apparatus 40 concerned stores the information in regard to the operating status of each of the other MFPs 10, which has been acquired through the abovementioned process, into the nonvolatile storage, such as the Hard Disc Drive or the like, provided within the own apparatus (Step S312). The items to be stored are indicated as a part of the history database 50 shown in FIG. 9, excluding the fields of “DETERMINED RESULT” and “USER” therefrom. Since the history information is stored into every information processing apparatus 40, the “USER” is automatically equivalent to the own information processing apparatus, and accordingly, it is unnecessary to store the information of this item. Further, since the management server 20 conducts the operation for determining “APPROPRIATE” or “INAPPROPRIATE”, the information processing apparatus 40 does not store this item.

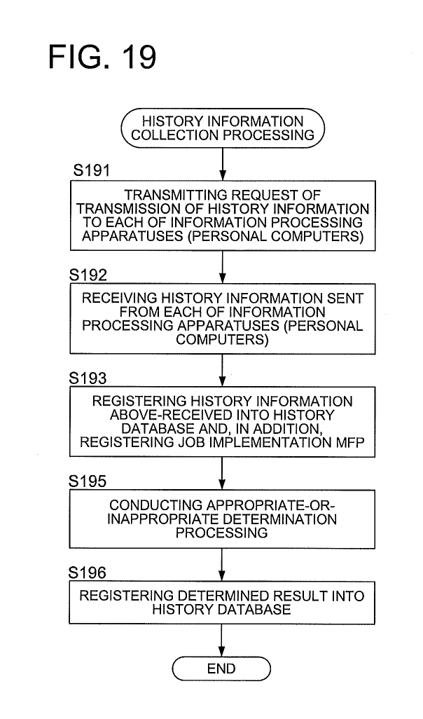

FIG. 19 shows a flowchart indicating a history information collection processing to be conducted by the management server 20 embodied in the present invention as the fourth embodiment. The history information collection processing is implemented at every predetermined period (for instance, once a day at a predetermined time), or at the time when the instruction is received from the manager or the like.

Initially, the management server 20 transmits a request of transmission of the history information to each of the information processing apparatuses 40 (Step S191). Receiving the request of transmission, the information processing apparatus 40 transmits the history information, currently stored in the own apparatus, to the management server 20. Receiving the history information sent from each of the information processing apparatuses 40 (Step S192), the management server 20 registers the history information above-received into the history database 50 (Step S193). On that occasion, the management server 20 also registers the information processing apparatus 40, serving as the sender of the history information concerned, as the “USER”.

Successively, the management server 20 conducts the appropriate-or-inappropriate determination processing (Step S195), so as to register the determined result thereof into the history database 50 (Step S196), and then, finalizes the processing (END). In this connection, the operation to be conducted in Step S195 is equivalent to that in Step S125 of the flowchart shown in FIG. 8, and the other operation to be conducted in Step S196 is equivalent to that in Step S126 of the flowchart shown in FIG. 8.

Referring to the drawings, various kinds of embodiments have been described in the foregoing. However, the scope of the present invention is not limited to the embodiments described in the foregoing. Modifications and/or additions made by a skilled person without departing from the spirit and scope of the invention shall be included in the scope of the present invention.

Although the management system 5 that includes the management server 20 as a separate apparatus has been exemplified in the aforementioned embodiments, it is applicable that, for instance, any one of the MFPs 10 is provided with the functions of the management server 20. Further, it is also applicable that the management system 5 is so constituted that all of the MFPs 10 are provided with the functions of the management server 20, so that every one of the MFPs 10 is capable of implementing the extraction processing shown in FIG. 11.

Further, although only the history information at the time of the sleep release is stored in each of the aforementioned embodiments, it is also applicable that the system is so constituted that history information in regard to all of the jobs are stored in advance, and then, only the history information at the time of the sleep release is extracted therefrom, so as to create the history database 50. In this case, release information, indicating whether or not the operation for the sleep release is conducted before implementing the job concerned, may be included in the history information in regard to all of the jobs, so as to extract only the history information at the time of the sleep release, based on the release information. For instance, in the third embodiment, by configuring the system in such a manner that each of the MFPs 10 stores the history information in regard to all of the jobs implemented by the own apparatus, so that, when receiving the request of transmission of the history information from the management server 20, the concerned MFP 10 extracts only the history information at the time of the sleep release so as to send it to the management server 20, it becomes possible to avoid the wasted data transmitting operations, resulting in an improvement of the system efficiency.

According to the management system embodied in the present invention, it becomes possible to store such the information that makes it possible to analyze the reason why the user has selected the image forming apparatus that is currently in the power saving mode. The result of analyzing the information concerned, for instance, can be utilized for updating the apparatus installation layout, or warning the selfish user.

While the preferred embodiments of the present invention have been described using specific term, such description is for illustrative purpose only, and it is to be understood that changes and variations may be made without departing from the spirit and scope of the appended claims.

What is claimed is:

1. A management system, comprising:
a plurality of image forming apparatuses, each of which is provided with a normal consumption mode and a power saving mode in which an amount of electric power consumption is lower than that in the normal consumption mode, as an electric power supplying mode, and each of which serves as a managed object to be managed in the management system;
a communication network through which the image forming apparatuses are communicatively coupled to each other; and
a storage section that serves as a part of a management server coupled to the communication network or is included in at least one of the image forming apparatuses or another apparatus coupled to the communication network;
wherein, when one of the image forming apparatuses resumes the normal consumption mode from the power saving mode to implement a job, the storage section acquires first information in regard to an operating status of the other image forming apparatus so as to store the first information therein.

2. The management system of claim 1,
wherein the storage section stores the first information in regard to the operating status of the other image forming apparatus, therein, only when one of the image forming apparatuses resumed the normal consumption mode from the power saving mode and has implemented the job.

3. The management system of claim 1,
wherein the storage section stores second information in regard to whether or not one of the image forming apparatuses resumed the normal consumption mode from the power saving mode and has implemented the job, and the first information in regard to the operating status of the other image forming apparatus at a time when implementing the job, while correlating the second information and the first information with each other.

4. The management system of claim 1,
wherein the operating status includes the electric power supplying mode.

5. The management system of claim 1,
wherein the operating status includes a number of reserved jobs and/or a waiting time defined as an time interval from a time when the job is inputted to anther time when implementation of the job is actually commenced.

6. The management system of claim 1,
wherein the storage section further stores job information in regard to the job implemented by resuming the normal consumption mode from the power saving mode, while collating the job information with the first information in regard to the operating status.

7. The management system of claim 6,
wherein the job information includes third information in regard to a user who has inputted the job concerned.

8. The management system of claim 6,
wherein the job information includes fourth information in regard to a kind of the job.

9. The management system of claim 1, further comprising:
an information providing section that serves as another part of the management server coupled to the communication network or is included in at least one of the image forming apparatuses or the other apparatus coupled to the communication network;
wherein the information providing section provides reference information, which is to be used for selecting a specific image forming apparatus from the image forming apparatuses, with a terminal device that will transmit the job to the specific image forming apparatus serving as a destination apparatus to which a job is to be transmitted.

10. The management system of claim 1,
wherein, in addition to the first information in regard to the operating status of the other image forming apparatus, the storage section also stores fifth information in regard to another operating status of said one of the image forming apparatuses that has implemented the job.

11. The management system of claim 1, further comprising:
the management server that is coupled to the communication network;
wherein each of the image forming apparatuses includes the storage section, so that, when said one of the image forming apparatuses resumed the normal consumption mode from the power saving mode and has implemented the job, said one of the image forming apparatuses stores the first information in regard to the operating status of the other image forming apparatus into the storage section of said one of the image forming apparatuses; and
wherein the management server collects the first information stored in each of the image forming apparatuses.

12. The management system of claim 1, further comprising:
the management server that is coupled to the communication network and provided with the storage section;
wherein, when said one of the image forming apparatuses resumed the normal consumption mode from the power saving mode and has implemented the job, said one of the image forming apparatuses notifies the management server of a fact that the normal consumption mode is resumed from the power saving mode and the job has been implemented in an own apparatus; and
wherein, when receiving a notification of the fact as abovementioned, the management server stores the first information in regard to the operating status of the other image forming apparatus into the storage section provided in the management server.

13. The management system of claim 1, further comprising:
the management server that is coupled to the communication network; and
a terminal device that is coupled to the communication network and includes the storage section;
wherein, when transmitting the job to said one of the image forming apparatuses, serving as a destination apparatus to which the job is to be transmitted, the terminal device stores the first information in regard to the operating status of the other image forming apparatus at the time when said one of the image forming apparatuses resumed the normal consumption mode from the power saving mode and has implemented the job, into the storage section of the terminal device; and
wherein the management server collects the first information stored in the storage section of the terminal device.

14. The management system of claim 1, further comprising:
the management server that is coupled to the communication network and provided with the storage section; and
a terminal device that is coupled to the communication network;
wherein, on an occasion that the terminal device transmits the job to said one of the image forming apparatuses, serving as a destination apparatus to which the job is to be transmitted, when said one of the image forming apparatuses resumes the normal consumption mode from the power saving mode to implement the job, the terminal device notifies the management server of a fact that the normal consumption mode is resumed from the power saving mode and the job will be implemented in said one of the image forming apparatuses; and
wherein, when receiving a notification of the fact as abovementioned, the management server stores the first information in regard to the operating status of the other image forming apparatus, other than said one of the image forming apparatuses, into the storage section provided in the management server.

15. A management apparatus that controls a plurality of image forming apparatuses, each of which is provided with a normal consumption mode and a power saving mode in which an amount of electric power consumption is lower than that in the normal consumption mode, as an electric power supplying mode, and each of which serves as a managed object to be managed by the management apparatus, comprising:
a control section to acquire first information in regard to an operating status of another image forming apparatus when one of the image forming apparatuses resumes the normal consumption mode from the power saving mode to implement a job; and
a storage section to store the first information in regard to the operating status of the other image forming apparatus, acquired by the control section, therein.

16. The management apparatus of claim 15,
wherein the storage section stores the first information in regard to the operating status of the other image forming apparatus, therein, only when one of the image forming apparatuses resumed the normal consumption mode from the power saving mode and has implemented the job.

17. The management apparatus of claim 15,
wherein the storage section stores second information in regard to whether or not one of the image forming apparatuses resumed the normal consumption mode from the power saving mode and has implemented the job, and the first information in regard to the operating status of the other image forming apparatus at a time when implementing the job, while correlating the second information and the first information with each other.

18. The management apparatus of claim 15,
wherein the operating status includes the electric power supplying mode.

19. The management apparatus of claim 15,
wherein the operating status includes a number of reserved jobs or a waiting time defined as an time interval from a time when the job is inputted to anther time when implementation of the job is actually commenced.

20. The management apparatus of claim 15,
wherein the storage section further stores job information in regard to the job implemented by resuming the normal consumption mode from the power saving mode, while collating the job information with the first information in regard to the operating status.

21. The management apparatus of claim 20,
wherein the job information includes third information in regard to a user who has inputted the job concerned.

22. The management apparatus of claim 15,
wherein, in addition to the first information in regard to the operating status of the other image forming apparatus, the storage section also stores fifth information in regard to another operating status of said one of the image forming apparatuses that has implemented the job.
